(19) United States
(12) Patent Application Publication
(10) Pub. No.: US 2025/0270968 A1
(43) Pub. Date: Aug. 28, 2025

(54) PISTON FOR AN INTERNAL COMBUSTION ENGINE, SUITABLE FOR AERODYNAMIC MOVEMENT OF GAS

(71) Applicant: IFP Energies nouvelles, RUEIL-MALMAISON (FR)

(72) Inventors: Xavier GAUTROT, RUEIL-MALMAISON CEDEX (FR); Paul-Georgian LUCA, RUEIL-MALMAISON CEDEX (FR)

(21) Appl. No.: 18/254,287

(22) PCT Filed: Nov. 15, 2021
(86) PCT No.: PCT/EP2021/081657

§ 371 Date: Oct. 11, 2023

(30) Foreign Application Priority Data
Nov. 27, 2020 (FR) FR2012294

(51) Int. Cl. F02F 3/28; F02B 23/10

(52) U.S. Cl. CPC F02F 3/285; F02B 23/10

(57) ABSTRACT

The present invention relates to a piston (1) of an internal-combustion engine, comprising recesses for intake (2) and exhaust (3) valves, and a connecting surface (4) between intake (2) and exhaust (3) valve recesses, this connecting surface (4) comprising an inclined portion (5) in the direction of the at least one exhaust valve recess (3).

### FIELD OF THE INVENTION

The present invention relates to the field of pistons for internal-combustion engines, in particular a spark-ignition internal-combustion engine.

An internal-combustion engine generally comprises at least a cylinder, a piston sliding in this cylinder in a reciprocating rectilinear motion, intake means for an oxidizer, burnt gas exhaust means, a combustion chamber and injection means for injecting a fuel.

### BACKGROUND OF THE INVENTION

As is generally admitted, when designing an engine, performance, pollutant emission and consumption constraints are increasingly high, therefore new solutions need to be found to increase the final engine efficiency.

Increasing the combustion efficiency thus is a key point to limit emissions for equal or greater performance. It is therefore of great importance that all of the fuel present in the combustion chamber be used by an oxidizer comprising for example air at ambient pressure, supercharged air, or a mixture of air (supercharged or not) and of recirculated burnt gas.

Indeed, the fuel mixture (oxidizer/fuel) in the combustion chamber needs to be as homogeneous as possible.

Furthermore, in order to ensure good efficiency and combustion rate, it is desirable to have a high turbulence level, and more specifically a high turbulent kinetic energy level, upon ignition of the fuel mixture and during the combustion thereof.

This high turbulence level can be obtained by means of particular intake aerodynamics, Swumble™ (IFP Energies nouvelles, France). This type of aerodynamics is characterized in that the macroscopic motion of the fuel mixture is a combination of swirl (rotational motion of the gas in the cylinder about a vertical cylinder axis) and tumble (rotational motion of the gas in the cylinder about a longitudinal engine axis).

Swirl, which is a macroscopic rotational motion of the fuel mixture about an axis collinear to the cylinder axis, is characterized by good motion conservation during the intake process, and more specifically during piston rise. It is an aerodynamic macroscopic motion that is generally used for compression-ignition internal-combustion engines, for which it is a good way to homogenize the fuel mixture.

Tumble is also a macroscopic rotational motion of the fuel mixture, but about an axis globally perpendicular to the cylinder axis. It has the specific feature of turning into microscopic aerodynamic motions that create turbulence as the piston rises. It is an aerodynamic macroscopic motion that is generally used for spark-ignition internal-combustion engines, for which it is a good way to obtain a suitable combustion rate. Besides, this motion is quite sensitive to the combustion chamber geometry and to the valve lift law, in terms of spread as well as maximum lift height.

Using Swumble™ (IFP Energies nouvelles, France) allows to benefit from the advantages of the two aerodynamic structures detailed above, and thus from excellent homogenization and a better combustion rate, thanks to a higher turbulence level during the compression phase than the levels observed with the best current spark-ignition engines. Swumble™ can be characterized notably by a continuous shift, throughout compression through the rise of the piston, of the axis of rotation of the aerodynamic gas motion, first highly inclined in the cylinder at compression start (strong swirl component), and finally substantially aligned with the longitudinal engine axis at compression end (strong tumble component).

These aerodynamic gas motions are generally produced by the shape of the intake pipe and of the combustion chamber. However, in order to guarantee that the combustion process thus created takes place under the best conditions possible, and to avoid creation of aerodynamic gas recirculation zones (that might generate a local turbulence decrease, or hot spot zones that could lead to abnormal combustions due to self-ignition, of knock or pre-ignition type), it is also advisable to optimize the shape of the piston so that it also takes part in this aerodynamic gas motion in the combustion chamber.

Various piston shapes have been developed. For example, patent application FR-2,771,138 describes a piston that comprises deflectors for directing the fuel jet. However, these deflectors also influence the aerodynamic motion of the gas, but they are not optimized to guarantee these aerodynamic gas motions. Similarly, patent application U.S. Pat. No. 6,725,828 describes a piston suitable for a direct-injection stratified-charge spark-ignition internal-combustion engine. The shape of the piston head is suited for fuel injection, but it also generates an aerodynamic gas motion, this piston shape is however not optimized to guarantee aerodynamic gas motion of swirl, tumble or Swumble™ type. According to another example, the utility model CN-20,787,786 relates to a piston with a central hollow and peripheral bosses for optimizing the tumble ratio and the turbulent kinetic energy. However, this shape does not allow the aerodynamic gas motion to be properly led towards the exhaust when the piston moves upward to the top dead center, and it might also generate hot spot zones.

In addition, conventionally, the piston head can comprise at least one intake valve recess and at least one exhaust valve recess, in order to enable opening of the intake and/or exhaust valves at the top dead center. These recesses however create aerodynamic gas recirculation zones in the combustion chamber. It is therefore important to optimize the piston shape to prevent formation of recirculation zones for pistons provided with recesses.

### SUMMARY OF THE INVENTION

The goal of the present invention is to allow the aerodynamic gas motion in the combustion chamber to be led towards the exhaust as the piston rises, and to avoid an aerodynamic recirculation zone likely to create a hot spot zone or a zone of low local turbulent kinetic energy level in the combustion chamber. The invention therefore relates to a piston of an internal-combustion engine, comprising intake and exhaust valve recesses, and a connecting surface between the intake and exhaust valve recesses, this connecting surface comprising an inclined portion in the direction of the at least one exhaust valve recess. This inclined portion allows to optimize the aerodynamic gas motion and to limit aerodynamic gas recirculation zones.

The invention relates to a piston of an internal-combustion engine, said piston comprising at least one intake valve recess and at least one exhaust valve recess, said piston comprising a connecting surface between said at least one intake valve recess and said at least one exhaust valve recess. Said connecting surface comprises an inclined portion, said inclined portion being secant with said at least one exhaust valve recess, and, in a plane perpendicular to the axis of said piston, a median axis of said inclined portion that separates said at least one intake valve recess and said at least one exhaust valve recess is offset relative to a median axis of said piston that separates said at least one intake valve recess and said at least one exhaust valve recess.

According to an embodiment, said inclined portion is plane.

Advantageously, said connecting surface not included in said inclined portion is plane and perpendicular to the axis of said piston.

According to an embodiment, said inclined surface is concave, the axis or the centre of said concavity of the inclined portion being non-secant with the axis of said piston.

Advantageously, said connecting surface not included in said inclined portion is concave, the axis or the centre of said concavity of said connecting surface being secant with the axis of said piston.

According to an implementation, said piston comprises two recesses, each for an intake valve.

According to an aspect, said piston comprises two recesses, each for an exhaust valve.

According to a feature, the angle of inclination of said inclined portion relative to a plane perpendicular to the piston axis is less than 25°, and it preferably ranges between 2° and 15°.

According to an embodiment, said inclined portion is secant with said at least one exhaust valve recess, with a radius of curvature ranging between 1 and 500 mm, preferably between 5 and 50 mm.

According to an embodiment option, at the intersection between said inclined portion and said at least one exhaust valve recess, the height between said inclined portion relative to said connecting surface is less than or equal to 10 mm, and it is preferably less than or equal to 5 mm.

According to an implementation, said inclined portion has a substantially rectangular shape in a plane perpendicular to the piston axis, and preferably a substantially square shape.

Furthermore, the invention relates to an internal-combustion engine, notably a spark-ignition internal-combustion engine, the engine comprising at least one cylinder, each cylinder comprising a piston according to one of the above features, said piston sliding in said cylinder, at least one intake pipe provided with an intake valve and at least one exhaust pipe provided with an exhaust valve, each cylinder comprising a combustion chamber, said combustion chamber being delimited by the upper face of said piston, by the inner face of said cylinder and by said cylinder head.

According to an embodiment, said cylinder head is roof-shaped.

According to an implementation, said at least one intake pipe comprises means for generating an aerodynamic gas motion within said cylinder about an axis substantially collinear to the axis of said cylinder and/or about an axis substantially perpendicular to the axis of said cylinder.

Furthermore, the invention relates to a use of an internal-combustion engine according to one of the above features for a Miller cycle or an Atkinson cycle.

### BRIEF DESCRIPTION OF THE FIGURES

Other features and advantages of the device according to the invention will be clear from reading the description hereafter, given by way of non limitative example, with reference to the accompanying figures wherein:

FIG. 1 illustrates a three-dimensional view of a piston according to a prior art,

FIG. 2 is a cross-sectional view of a piston according to a prior art,

FIG. 3 illustrates a three-dimensional view of a piston according to an embodiment of the invention,

FIG. 4 illustrates a cross-sectional view of a piston according to an embodiment of the invention,

FIG. 5 illustrates an aerodynamic gas motion in the combustion chamber for a piston according to the prior art, and

FIG. 6 illustrates an aerodynamic gas motion in the combustion chamber for a piston according to an embodiment of the invention.

### DETAILED DESCRIPTION OF THE INVENTION

The invention relates to a piston of an internal-combustion engine, in particular for a spark-ignition internal-combustion engine. The piston comprises, on the head thereof, i.e. on the face of the piston opposite the cylinder head of the internal-combustion engine (referred to as upper face of the piston), at least one intake valve recess and at least one exhaust valve recess. Recesses are hollows provided on the upper face of the piston to allow passage of intake and/or exhaust valves. Generally, intake valve recesses can be different from exhaust valve recesses. These recesses allow to obtain a compact device occupying a small volume, and they enable opening of the intake and exhaust valves at the piston top dead center.

In addition, the upper face of the piston comprises a connecting surface between the at least one intake valve recess and the at least one exhaust valve recess. The connecting surface can be plane or curved.

According to the invention, the connecting surface comprises an inclined portion in the direction of the at least one exhaust valve recess. The portion is inclined relative to a plane perpendicular to the axis of the piston. In other words, at least a part of the connecting surface is inclined, and its inclination is directed towards the at least one exhaust valve recess. This inclined portion allows the aerodynamic gas motion to be sent to the exhaust.

Furthermore, the inclined portion is secant with the at least one exhaust valve recess. The deepest zone of the inclined portion is at the intersection with the at least one exhaust valve recess. Thus, the at least one exhaust valve recess does not form a gas recirculation zone in the combustion chamber.

Besides, in a plane perpendicular to the axis of the piston, a median axis of the inclined portion that separates on one side the at least one intake valve recess and on the other side the at least one exhaust valve recess is offset relative to a median axis of the piston that separates on one side the at least one intake valve recess and on the other side the at least one exhaust valve recess. A median axis is understood to be an axis equidistant from opposite sides or points of the shape considered (shape of the piston or inclined portion). In other words, in a plane perpendicular to the axis of the piston (which can correspond to a top view of the piston when it is arranged vertically), the inclined portion is not centered with the piston, and this decentering is provided in a direction passing through the at least one intake valve recess and through the at least one exhaust valve recess. Due to the intersection between the inclined portion and the at least one exhaust valve recess, and due to this decentering, the median axis of the inclined portion is closer to the at least one exhaust valve recess than to the at least one intake valve recess.

According to an embodiment of the invention, the inclined portion can be plane. For this embodiment, the connecting surface not included in the inclined portion can be plane, and it can be perpendicular to the axis of the piston. The expression “connecting surface not included in the inclined portion” designates the connecting surface between the at least one intake valve recess and the at least one exhaust valve recess except the inclined portion. This connecting surface design is simple.

In a variant, the inclined portion can be concave (curved, lens shaped). Preferably, the concavity of the inclined portion can consist of a portion of a cylinder or a portion of a sphere. Considering the inclined portion decentering, the axis (in the case of a cylinder portion for example) or the centre (in the case of a sphere portion for example) of the concavity is not secant with the axis of the piston. In other words, the centre or the axis of the inclined portion concavity is offset relative to the axis of the piston. The inclined portion concavity improves the combustion within the combustion chamber by improving the shape of the volume thereof.

For this embodiment, the connecting surface not included in the inclined portion can be concave (curved, lens shaped). Preferably, the concavity of the connecting surface can consist of a portion of a cylinder or a portion of a sphere. The axis (in the case of a cylinder portion for example) or the centre (in the case of a sphere portion for example) of the concavity is secant with the axis of the piston. In other words, the centre of the connecting surface concavity belongs to the axis of the piston, or the axis of the connecting surface concavity belongs to the axis of the piston.

For the latter implementation, the radius of concavity (radius of the cylinder or of the sphere) of the connecting surface can be greater than the radius of concavity (radius of the cylinder or of the sphere) of the inclined portion. The radii of concavity can be great in relation to the size of the piston. According to a non-limitative example, the radii can be several hundred mm, they can for example range between 100 and 1000 mm, preferably between 200 and 600 mm. Thus, the curvature of the connecting surface is greater for the inclined portion, which promotes direction of the aerodynamic gas motion towards the exhaust.

Alternatively, for this embodiment, the connecting surface not included in the inclined portion can be plane, and it can be perpendicular to the axis of the piston.

Preferably, the connecting surface may comprise no protruding element. Indeed, protruding elements promote modification of the aerodynamic gas motion.

According to an embodiment of the invention, the piston can comprise two intake valve recesses. Thus, the piston is suitable for an internal-combustion engine with two intake valves.

Alternatively or cumulatively, the piston can comprise two exhaust valve recesses. Thus, the piston is suitable for an internal-combustion engine with two exhaust valves.

Preferably, the piston can comprise two intake valve recesses and two exhaust valve recesses. Thus, the piston is suitable for an internal-combustion engine with four valves. For this embodiment, the two intake valve recesses can be close to one another, and the two exhaust valve recesses can be close to one another.

In order to optimize the aerodynamic gas motion in the combustion chamber, the angle of inclination of the inclined portion relative to a plane perpendicular to the axis of the piston can be less than 25°, and it can preferably range between 2° and 15°.

When the inclined portion is plane, the angle of inclination corresponds to the angle formed between the plane of the inclined portion and a plane perpendicular to the axis of the piston. When the inclined portion is concave or non-plane, the angle of inclination can be defined, in a cutting plane passing through an intake recess and an exhaust recess, and that is parallel to the axis of the piston, by the angle formed between a line passing through the highest point and through the lowest point of the inclined portion, and a line belonging to a plane perpendicular to the axis of the piston.

According to an implementation of the invention, the inclined portion can be secant with the at least one exhaust valve recess, with a radius of curvature ranging between 1 and 500 mm, preferably between 5 and 50 mm. This radius of curvature allows to avoid too abrupt intersections that may generate gas recirculation zones in the combustion chamber.

According to an aspect of the invention, at the intersection between the inclined portion and the at least one exhaust valve recess, the height of the inclined portion (the dimension of the inclined portion in a direction parallel to the axis of the piston) relative to the connecting surface not included in the inclined portion can be less than or equal to 10 mm, and it is preferably less than or equal to 5 mm. Thus, this height allows to guarantee an optimized intersection with the at least one exhaust valve recess.

According to an embodiment of the invention, in a plane perpendicular to the axis of the piston, the inclined portion can have substantially the shape of a quadrilateral, preferably of a rectangle or a trapezoid, and for example substantially the shape of a square. Preferably, at least one side of the quadrilateral (more preferably, two sides of the quadrilateral) can be parallel to a median axis of the piston that separates on one side the at least one intake valve recess and on the other side the at least one exhaust valve recess. When the piston comprises two exhaust valve recesses, one side of the quadrilateral can correspond to a line segment between the two exhaust valve recesses. This shape provides a good surface for orienting the aerodynamic gas motion.

For this embodiment, the connecting surface not included in the inclined portion can have substantially the shape of a U in a plane perpendicular to the axis of the piston. Preferably, the inclined portion can have a symmetrical shape relative to a plane comprising the axis of the piston and an axis perpendicular to the median axis of the inclined portion that separates, on one side, the at least one intake valve recess and, on the other side, the at least one exhaust valve recess. This symmetry provides symmetry of the piston and good gas distribution, in particular when two exhaust valve recesses are provided. It is noted that the axis of symmetry is perpendicular to the median axis of the inclined surface that separates, on one side, the at least one intake valve recess and, on the other side, the at least one exhaust valve recess. This axis of symmetry is also perpendicular to the median axis of the piston that separates, on one side, the at least one intake valve recess and, on the other side, the at least one exhaust valve recess. According to an implementation of the invention, in a plane perpendicular to the axis of the piston, the inclined portion can represent at least 40% and at most 80% of the total connecting surface. Thus, a large part of the connecting surface is used for orienting the aerodynamic gas motion.

The inclined portion can be made directly during manufacture of the piston, for example by casting or by additive manufacturing. Alternatively, the inclined portion can be made by machining.

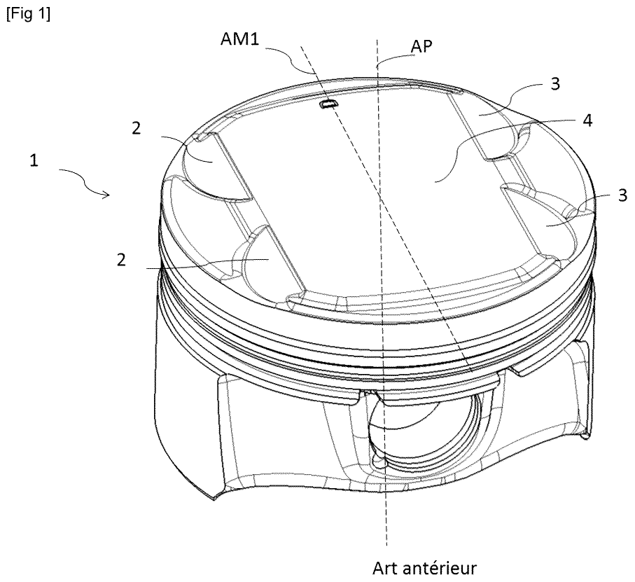

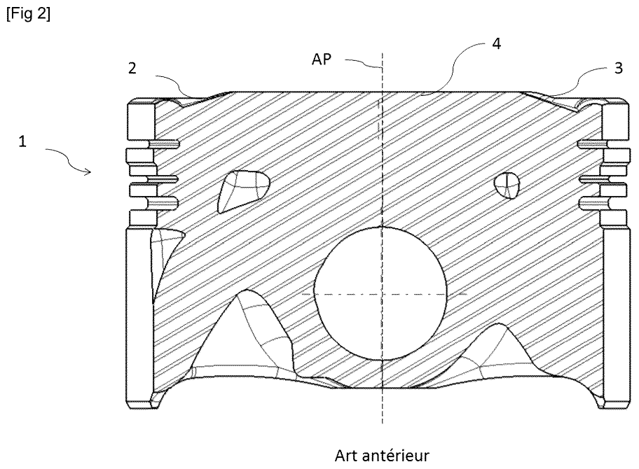

FIGS. 1 and 2 schematically illustrate, by way of non-limitative example, a piston according to a prior art. FIG. 1 is a three-dimensional view of the piston, and FIG. 2 is a cross-sectional view of the piston in a plane passing through an intake valve recess and an exhaust valve recess. Piston 1 comprises two intake valve recesses 2. Piston 1 also comprises two exhaust valve recesses 3. A plane connecting surface 4 is provided between intake valve recesses 2 and exhaust valve recesses 3. FIG. 1 shows the axis AP of the piston, substantially vertical here, and the median axis AM1 of piston 1; this median axis AM1 of the piston separates, on one side, intake valve recesses 2 and, on the other side, exhaust valve recesses 3.

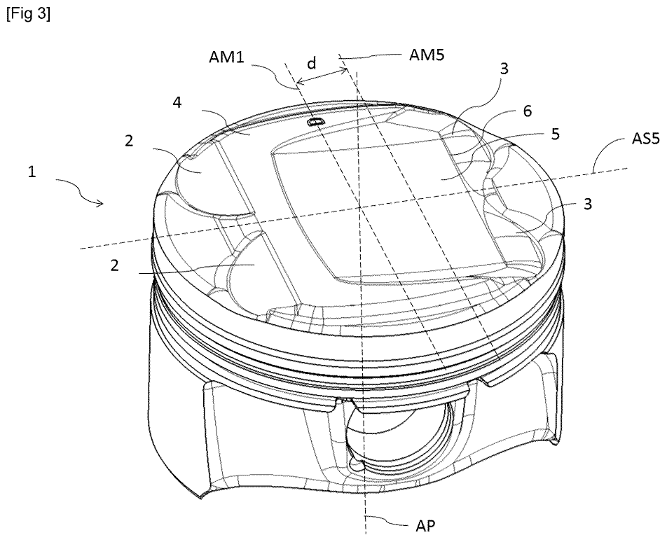

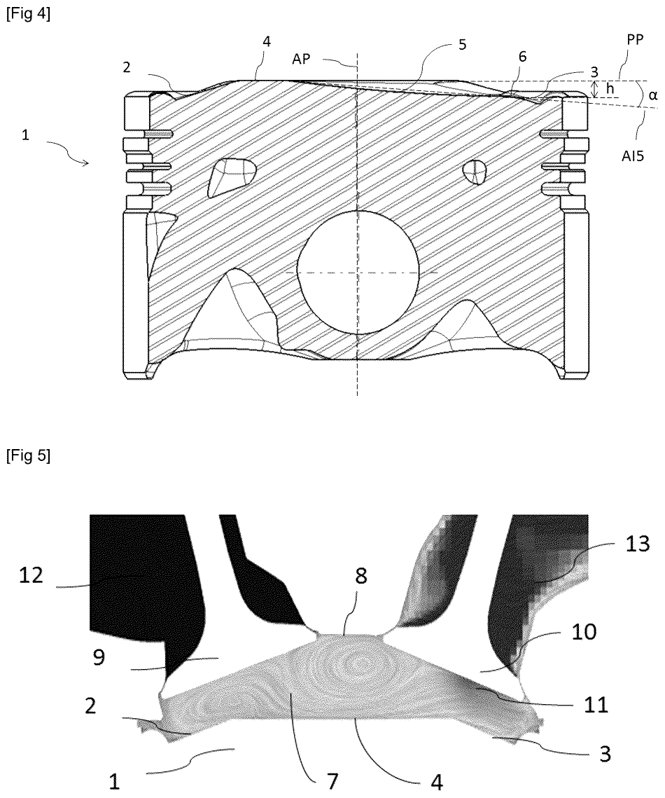

FIGS. 3 and 4 schematically illustrate, by way of non-limitative example, a piston according to an embodiment of the invention. FIG. 3 is a three-dimensional view of the piston, and FIG. 4 is a cross-sectional view of the piston in a plane passing through an intake valve recess and an exhaust valve recess. Piston 1 comprises two intake valve recesses 2. Piston 1 also comprises two exhaust valve recesses 3. A connecting surface 4 is provided between intake valve recesses 2 and exhaust valve recesses 3. Connecting surface 4 comprises at least an inclined portion 5 oriented towards exhaust valve recesses 3. For the embodiment illustrated, in top view (in a plane perpendicular to the axis of the piston), the inclined portion substantially has the shape of a rectangle, and the remaining part of the connecting surface substantially has the shape of a U. Inclined portion 5 has a concave shape and the rest of connecting surface 4 is plane.

FIG. 3 shows the axis AP of the piston, substantially vertical here, and the median axis AM1 of piston 1; this median axis AM1 separates on one side intake valve recesses 2 and, on the other side, exhaust valve recesses 3. Furthermore, the figure also shows the median axis AM5 of the inclined portion, which separates on one side intake valve recesses 2 and, on the other side, exhaust valve recesses 3. This median axis AM5 of inclined portion 5 is offset by a distance d relative to median axis AM1 of piston 1. In addition, the figure shows an axis of symmetry AS5 of inclined portion 5 that defines a plane of symmetry of piston 1 with piston axis AP.

FIG. 4 shows axis AP of the piston, an axis PP perpendicular to piston axis AP (thus belonging to a plane perpendicular to the axis of the piston). Reference 6 designates the intersection between inclined portion 5 and exhaust valve recesses 3. The height between intersection 6 and the connecting surface not included in inclined portion 4 is denoted by h. Additionally, the angle of inclination of inclined portion 5 relative to a plane PP perpendicular to the axis of the piston is denoted by a. This angle is defined in relation to an axis of inclination A15 passing in the cutting plane of FIG. 4 through the highest point and the lowest point of inclined portion 5.

Furthermore, the present invention relates to an internal-combustion engine comprising at least one cylinder, each cylinder being provided with:
at least one intake device advantageously equipped with an intake valve, for supplying gas to the cylinder,
at least one exhaust device for discharging the burnt gas from the cylinder, the exhaust device being advantageously equipped with an exhaust valve,
a cylinder head comprising at least the at least one intake device and the at least one exhaust device,
a piston having a reciprocating rectilinear translational motion in the cylinder for generating mechanical energy from combustion (by rotation of a crankshaft), the piston being consistent with one of the variants or variant combinations described above, and
fuel injection means, for generating combustion.

Within the cylinder, a combustion chamber is made up of the upper surface of the piston, the cylinder wall and the cylinder head.

According to an embodiment, the fuel injection means can be direct injection means, i.e. the fuel injection means are directly arranged in the cylinder.

Alternatively, the fuel injection means can be indirect injection means, i.e. the fuel injection means are arranged in the intake device.

According to an implementation of the invention, the internal-combustion engine is a spark-ignition engine. In this case, the engine further comprises at least one plug for generating combustion of the gas/fuel mixture.

Alternatively, the internal-combustion engine is a compression-ignition engine. In this case, the engine comprises no plug for generating combustion of the gas/fuel mixture.

The internal-combustion engine can comprise a plurality of cylinders, notably 3, 4, 5 or 6 cylinders.

Preferably, the combustion engine can be an engine with four valves per cylinder (two intake valves and two exhaust valves).

According to an embodiment of the invention, the cylinder head can be substantially roof shaped (triangular “in volume”). This cylinder head shape provides an optimized shape for the combustion chamber and promotes motion of the gas in relation to a plane shape of the cylinder head.

According to an implementation of the invention, the cylinder can comprise means for generating an aerodynamic gas motion within the combustion chamber about an axis substantially collinear to the cylinder axis (corresponding to the piston axis), thus generating swirl motion.

Alternatively or additionally, the cylinder can comprise means for generating an aerodynamic gas motion within the combustion chamber about an axis substantially perpendicular to the cylinder axis (corresponding to the piston axis), thus generating tumble motion.

Preferably, the cylinder can comprise means for generating an aerodynamic gas motion within the combustion chamber about an axis substantially collinear to the cylinder axis, and about an axis substantially perpendicular to the cylinder axis, thus generating Swumble™ motion. The present invention is particularly suitable for this embodiment, considering that the piston allows the turbulent gas motion to be effectively directed in particular towards the exhaust when the piston moves upward to the top dead centre.

For this embodiment, the intake device can be designed to generate tumble, swirl or Swumble™ motions.

For example, the intake device can comprise an intake pipe with a ramp shape and/or a convergence of the intake pipe flow area, and/or an inclination of the intake pipe and/or a mask and/or a rotation of the end of the intake pipe, etc.

The intake pipe can notably be consistent with one of the intake pipes described in the following patent applications: FR-3,080,888 (WO-2019/211,040), FR-3,091,906 (WO-2020/151,985), FR-3,095,235 (WO-2020/212,115), FR-3,095,236 (WO-2020/212,117), and FR-3,095,237 (WO-2020/212,112).

Furthermore, the present invention relates to the operation of an internal-combustion engine according to one of the variants or variant combinations described above on a Miller cycle or an Atkinson cycle.

The Miller cycle is a thermodynamic cycle characterized by closing of the intake valve(s) before the bottom dead centre of the piston during the intake phase. This allows to increase the geometric compression ratio at iso effective compression ratio, and thus to provide increased work recovery via the expansion ratio increase, in addition to cooling of the charge admitted. The intake device according to the invention is particularly suited for operation on a so-called Miller cycle over a wide operating range, thanks to the generation of a Swumble™ type aerodynamic gas motion.

The Atkinson cycle is a standard thermodynamic cycle used notably in combustion engines.

The internal-combustion engine according to the invention can be used in the field of embedded applications, such as road, sea or air transport, or in the field of stationary installations such as a generator set.

It is clear that the invention is not limited to the piston embodiments described above by way of example, and that it encompasses any variant embodiment.

### COMPARATIVE EXAMPLE

The features and advantages of the piston according to the invention will be clear from reading the application example below.

For this comparative example, the aerodynamic gas motion in the combustion chamber of a cylinder equipped with a piston according to an embodiment of the invention (according to the embodiment of FIGS. 3 and 4) is compared, by computational fluid dynamics (CFD) simulation, with the aerodynamic gas motion in the combustion chamber of a cylinder equipped with a piston according to a prior art (according to the prior art of FIGS. 1 and 2), the intake and the exhaust being identical for both simulations, in particular the intake pipe is configured to generate an aerodynamic gas motion of Swumble™ type.

FIG. 5 is a schematic cross-sectional view of the combustion system at the end of the compression stroke at top dead centre with a piston according to the prior art. This figure shows (in white) the upper face of piston 1 with an intake valve recess 2, an exhaust valve recess 3 and a plane connecting surface 4. A roof-shaped cylinder head 8 with an intake valve 9 (in white) in an intake pipe 12, and an exhaust valve 10 (in white) in an exhaust pipe 13 are also shown. It can be seen in this figure that the aerodynamic gas motion (grey streamlines) is confined to the centre of combustion chamber 7 and does not penetrate beneath exhaust valves 3, thus creating a high-temperature zone 11.

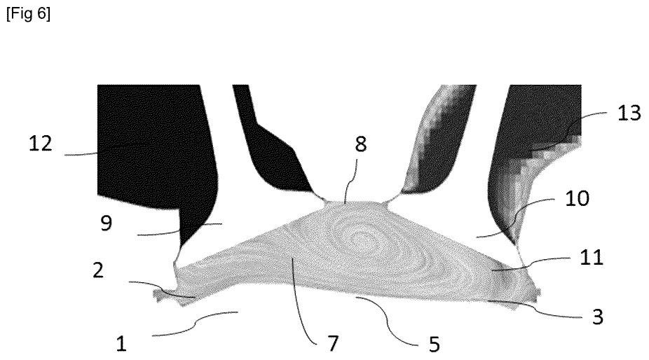

FIG. 6 is a schematic and non-limitative cross-sectional view of the combustion system at the end of the compression stroke at top dead centre with a piston according to an embodiment of the invention. This figure shows (in white) the upper face of piston 1 with an intake valve recess 2, an exhaust valve recess 3 and a connecting surface with a concave inclined portion 5. A roof-shaped cylinder head 8 with an intake valve 9 (in white) in an intake pipe 12, and an exhaust valve 10 (in white) in an exhaust pipe 13 are also shown. It can be seen in this figure that the aerodynamic gas motion (grey streamlines) is much more developed and that it extends beneath the exhaust valves, thus eliminating the high-temperature zone (zone 11 is greatly reduced in relation to FIG. 5).

Thus, the invention allows the aerodynamic gas motion to be effectively directed in the combustion chamber towards the exhaust when the piston moves upward to the top dead centre, and it limits high-temperature zones.

1. A piston of an internal-combustion engine, said piston (1) comprising at least one recess (2) for an intake valve and at least one recess (3) for an exhaust valve, said piston (1) comprising a connecting surface (4) between said at least one intake valve recess (2) and said at least one exhaust valve recess (3), characterized in that said connecting surface (4) comprises an inclined portion (5), said inclined portion (5) being secant with said at least one exhaust valve recess (3), and in that, in a plane perpendicular to the axis of said piston (AP), a median axis of said inclined portion (AM5) that separates said at least one intake valve recess (2) and said at least one exhaust valve recess (3) is offset relative to a median axis of said piston (AM1) that separates said at least one intake valve recess (2) and said at least one exhaust valve recess (3).

2. An internal-combustion engine piston as claimed in claim 1, wherein said inclined portion (5) is plane.

3. An internal-combustion engine piston as claimed in claim 2, wherein said connecting surface not included in said inclined portion is plane and perpendicular to the axis of said piston (AP).

4. An internal-combustion engine piston as claimed in claim 1, wherein said inclined portion (5) is concave, the axis or the centre of said concavity of inclined portion (5) being non-secant with the axis of said piston (AP).

5. An internal-combustion engine piston as claimed in claim 4, wherein said connecting surface not included in said inclined portion is concave, the axis or the centre of said concavity of said connecting surface being secant with the axis of said piston (AP).

6. An internal-combustion engine piston as claimed in claim 1, wherein said piston comprises two intake valve recesses (2).

7. An internal-combustion engine piston as claimed in claim 1, wherein said piston comprises two exhaust valve recesses (3).

8. An internal-combustion engine piston as claimed in claim 1, wherein the angle of inclination (a) of said inclined portion (5) relative to a plane perpendicular to piston axis (AP) is less than 25°, and it preferably ranges between 2° and 15°.

9. An internal-combustion engine piston as claimed in claim 1, wherein said inclined portion (5) is secant with said at least one exhaust valve recess (3), with a radius of curvature ranging between 1 and 500 mm, preferably between 5 and 50 mm.

10. An internal-combustion engine piston as claimed in claim 1 wherein, at the intersection (6) between said inclined portion (5) and said at least one exhaust valve recess (3), the height (h) between said inclined portion (5) relative to said connecting surface is less than or equal to 10 mm, and it is preferably less than or equal to 5 mm.

11. An internal-combustion engine piston as claimed in claim 1, wherein said inclined portion (5) has a substantially rectangular shape in a plane perpendicular to piston axis (AP), and preferably a substantially square shape.

12. An internal-combustion engine, notably a spark-ignition internal-combustion engine, the engine comprising at least one cylinder, each cylinder comprising a piston (1) as claimed in claim 1, said piston (1) sliding in said cylinder, at least one intake pipe (12) provided with an intake valve (9) and at least one exhaust pipe (13) provided with an exhaust valve (10), each cylinder comprising a combustion chamber (7), said combustion chamber (7) being delimited by the upper face of said piston (1), by the inner face of said cylinder and by said cylinder head.

13. An internal-combustion engine as claimed in claim 12, wherein said cylinder head is roof-shaped (8).

14. An internal-combustion engine as claimed in claim 12, wherein said at least one intake pipe (12) comprises means for generating an aerodynamic gas motion within said cylinder about an axis substantially collinear to the axis of said cylinder and/or about an axis substantially perpendicular to the axis of said cylinder.

15. Use of an internal-combustion engine as claimed in claim 12 for a Miller cycle or an Atkinson cycle.

16. A method of operating the internal-combustion engine as claimed in claim 12, comprising operating the internal-combustion engine according to a Miller cycle.

17. A method of operating the internal-combustion engine as claimed in claim 12, comprising operating the internal-combustion engine according to an Atkinson cycle.
